(19) United States
(12) Patent Application Publication
(10) Pub. No.: US 2009/0296932 A1
(43) Pub. Date: Dec. 3, 2009

(54) ENCRYPTED VOIP CALLS

(76) Inventor: EMIL-EMIR PILAVIC, HELSINGBORG (SE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 12/129,864

(22) Filed: May 30, 2008

(51) Int. Cl. H04L 9/00

(52) U.S. Cl. 380/255

(57) ABSTRACT

The invention regards a system and a method to encrypted calls through a voice over Internet protocol in at least one of a telecommunication and a data network. Every call in the network (10) is encrypted in a voice over Internet protocol server (26) with a key from a key generator (28) comprising an encryption algorithm.

### TECHNICAL FIELD

The present invention pertains to a system and a method to encrypted calls through a voice over Internet protocol in at least one of a telecommunication and a data network.

### BACKGROUND ART

As the World Wide Web (www) or the Internet is in a constant changing mode, through for instance making phone calls, streaming video and other multimedia services, there is a need for a safe communication over the internet. An unsafe call could be eavesdropped and crucial know how could be lost by corporations and other multimedia users.

It is also of interest that government agencies can detect threats against their countries without having to listen in to every call made on the www.

The invention presented below addresses problems related to these questions.

### SUMMARY OF THE INVENTION

An aim of the present invention is to provide encrypted voice over Internet protocol (VoIP) calls.

Hence, the present invention sets forth a system adapted to encrypted telephony through a voice over Internet protocol in at least one of a telecommunication and a data network. Hereby, the invention comprises:

a voice over Internet protocol server setting up calls between at least two voice over Internet protocol clients calling each other through the network;

the voice over Internet protocol clients comprising an AGE™ voice over Internet protocol client application adapted to encrypted calls;

an encryption key generator connected to the server adapted to generate at least one unique key for every set up call encrypted in the network;

the key generator comprising an encryption algorithm receiving the key which activates the encryption algorithm to encrypt the calls between the voice over Internet protocol clients; and

the voice over Internet protocol clients receiving the key to decode the encrypted call by comprising the encryption algorithm.

One embodiment of the present invention comprises the following modules connected to the voice over Internet protocol server:

a data storage module storing encrypted data;

a key storage module storing every used key to encrypt a single call:

a voice storage module storing encrypted speech; and

a header storage module connecting every made data or speech call stored, to a key stored in the key storage module, thus being able to recall every call made.

Yet another embodiment comprises that a single call is encrypted with new keys on the basis of the elapsing of a predetermined time period.

A still further embodiment comprises that a single call is encrypted with new keys on the basis of random time periods.

Moreover, the present invention sets forth a method for encrypted telephony through voice over Internet protocol in at least one of a telecommunication and a data network. The invention method thus comprises:

setting up calls between at least two voice over Internet protocol clients calling each other through the network through a voice over Internet protocol server;

the voice over Internet protocol clients comprising an AGE™ voice over Internet protocol client adapted to encrypted calls;

generating through an encryption key generator connected to the server at least one unique key for every set up call encrypted in the network;

the key generator comprising an encryption algorithm receiving the key which activates the encryption algorithm to encrypt the calls between the voice over Internet protocol clients; and

the voice over Internet protocol clients receiving the key to decode the encrypted call by comprising the encryption algorithm.

In one embodiment of the present invention it comprises:

storing encrypted data in a data storage module;

storing every used key to encrypt a single call in a key storage module

storing encrypted speech in a voice storage module; and

storing headers in a header storage module connecting every made data or speech call stored, to a key stored in the key storage module, thus being able to recall every call made.

Yet one embodiment comprises that a single call is encrypted with new keys on the basis of the elapsing of a predetermined time period.

Yet a further embodiment comprises that a single call is encrypted with new keys on the basis of random time periods.

### BRIEF DESCRIPTION OF THE DRAWINGS

Henceforth reference is had to the attached figure in the accompanying text of the description for a better understanding of the present invention with its embodiments and given examples, wherein:

FIG. 1 schematically illustrates one embodiment of a system and a method adapted to encrypted voice over Internet protocol (VOIP) calls in accordance with the present invention.

### DETAILED DESCRIPTION OF PREFERRED EMBODIMENTS

An aim of the present invention is to provide a new and inventive encryption to voice over Internet protocol (VoIP) communication. Such communication/calls can be made between end to end users/VoIP clients having devices such as a cellular phone, computer and headset, special cordless IP telephones, to transfer data, including speech and streaming video and other multimedia services, in order to accomplish a safe transmission from and to such devices.

The present invention provides a plurality of application embodiments utilizing its encryption technology for safer communication of information and data.

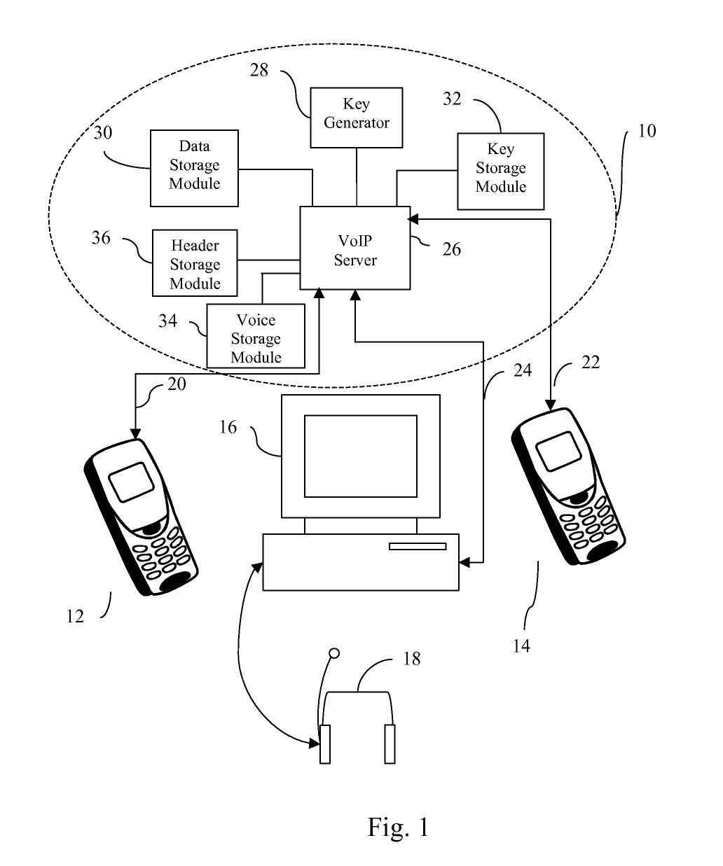

FIG. 1 schematically illustrates one embodiment of a system adapted to encrypted voice over Internet protocol (VOIP) telephony in accordance with the present invention, and a method therefore is described. In FIG. 1, an IP multimedia subsystem (IMS) network 10 residing in the Internet or www is schematically depicted in broken lines. As an example of the utilization of the present invention encryption, two cellular phones 12, 14 are depicted in FIG. 1. Moreover, a PC 16 is depicted having VoIP call abilities through for instance a headset 18. The cellular phones 12, 14 and PC 16 are named VoIP clients, i.e., different clients that are able to connect to a VoIP server 26 for communication. These devices or a USB device and memory cards are equipped with an AGE™ VoIP client application, which is utilized for encrypted speech, conference calls, chat messages and to transmit data files such as Word files, pictures, videos, SMS, MMS and the like.

A call in the sentence of the present invention can be speech, video call, SMS, MMS, conference call, pictures and other multimedia services transmitted through VoIP.

Calls between end to end user devices/VoIP clients 12, 14, 16 is schematically illustrated as being made over the lines 20, 22, 24 depicted as double arrows in FIG. 1. Such calls are administrated through an IP multimedia subsystem (IMS) network 10 comprising application servers (ASs) which host and execute services, often named session initiation protocol servers (SIP servers) 26, which set up SIP calls through the Internet or other like protocols utilized by a VoIP server 26. The VoIP server 26 according to the present invention has in one embodiment a key generator 28 connected to the server 26. The key generator comprises for instance the Diffie-Hellman key agreement/key encryption exchange protocol, RSA (Rivest-Shamir-Adleman), Ghost and the like, which allow at least two end user devices 12, 14, 16 to exchange a secret key over an insecure medium without any prior secrets. The RSA and Ghost can be utilized both as encryption algorithms and key encryption protocols. When the expression that a device is connected to the VoIP server 26 is utilized in the present description it is meant to include that it could be comprised in the VoIP server 26. A key generator 28 is a hardware device and hard coded, which for instance can be a plug in device to the server 26. As the key generator 28 is hard coded it can not be tampered with by for instance hackers and the like, as is common with software.

A key generated by the key generator 28 key encryption protocol is utilized by an encryption algorithm residing in the key generator 28 for instance one of the well known cryptography/encryption algorithms named Blowfish, TwoFish, RSA, Ghost and the like to provide the key. Blowfish is a keyed symmetric block cipher designed by Bruce Schneier. All the mentioned encryption algorithms and key encryption protocols are well known to a person skilled in the art.

The generated key is utilized to encrypt a call between for instance the two cellular phones 12 and 14 or between two PC's 16 or between any at least two devices, comprising an AGE™ VoIP client application to receive a key from the key generator 28. Every call through the VoIP server 26, according to the present invention, is provided its own unique key by the key generator 28, which is utilized by the encryption algorithm to encrypt a single call between at least two VoIP clients 12, 14, 16. For the VoIP clients 12, 14, 16 to be able to decode and listen or/and view a call, the generated key is transmitted to the VoIP clients 12, 14, 16 AGE™ VoIP client application which comprise an encryption algorithm such as the one housed in the in the key generator 28.

For instance, the Diffie-Hellman key encryption protocol can handle keys the size of 1024, 2048 and 4096 bit or more, making it almost impossible to crack an encryption when the key of the present invention is unique for every single call made.

In one embodiment of the present invention a data memory/saver/storage module 30, saving/storing all encrypted data, is connected to the VoIP server 26. Furthermore, a key memory/storage module 32 is connected to the VoIP server 26 storing all utilized generated keys connected to one unique call in a data memory/saver/storage module 30 or in a voice/speech memory/storage module 34 depicted in FIG. 1.

In FIG. 1 is also depicted a header storage module 36, which stores data about who called whom, date, time and the length of the call.

If a call made over the VoIP server has to be recalled, it is possible to connect each saved data call in the data storage module 30 to a at least one key stored in the key storage module 32, which key relates to a header in the header memory module 36, as well as each voice call made stored in the voice storage module 34. The stored keys are thus utilized to decode the one unique call made and stored in the data storage 30.

Another embodiment comprises that a single call is encrypted with new keys on the basis of the elapsing of a set predetermined time period such as for instance 3 seconds or any other suitable time period for a call. A single call could also be encrypted with new keys on the basis of suitable random time periods through for instance a random generator.

The present invention is not limited to given examples and embodiments, but to what a person skilled in the art can derive from the attached set of claims.

1. A system adapted to encrypted calls through a voice over Internet protocol in at least one of a telecommunication and a data network, characterized in that it comprises:
a voice over Internet protocol server setting up calls between at least two voice over Internet protocol clients calling each other through said network;
said voice over Internet protocol clients comprising an voice over Internet protocol client application adapted to encrypted calls;
an encryption key generator connected to said server adapted to generate at least one unique key for every set up call encrypted in said network;
said key generator comprising an encryption algorithm receiving said key which activates said encryption algorithm to encrypt said calls between said voice over Internet protocol clients; and
said voice over Internet protocol clients receiving said key to decode the encrypted call by comprising said encryption algorithm.

2. A system according to claim 1, wherein it comprises the following modules connected to the voice over Internet protocol server:
a data storage module storing encrypted data;
a key storage module storing every used key to encrypt a single call:
a voice storage module storing encrypted speech; and
a header storage module connecting every made data or speech call stored, to a key stored in said key storage module, thus being able to recall every call made.

3. A system according to claim 1, wherein a single call is encrypted with new keys on the basis of the elapsing of a predetermined time period.

4. A system according to claim 1, wherein a single call is encrypted with new keys on the basis of random time periods.

5. A method adapted to encrypted calls through a voice over Internet protocol in at least one of a telecommunication and a data network, characterized in that it comprises:
setting up calls between at least two voice over Internet protocol clients calling each other through said network through a voice over Internet protocol server;
said voice over Internet protocol clients comprising a voice over Internet protocol client adapted to encrypted calls;
generating through an encryption key generator connected to said server at least one unique key for every set up call encrypted in said network;
said key generator comprising an encryption algorithm receiving said key which activates said encryption algorithm to encrypt said calls between said voice over Internet protocol clients; and
said voice over Internet protocol clients receiving said key to decode the encrypted call by comprising said encryption algorithm.

6. A method according to claim 5, wherein it comprises:
storing encrypted data in a data storage module;
storing every used key to encrypt a single call in a key storage module
storing encrypted speech in a voice storage module; and
storing headers in a header storage module connecting every made data or speech call stored, to a key stored in said key storage module, thus being able to recall every call made.

7. A method according to claim 5, wherein a single call is encrypted with new keys on the basis of the elapsing of a predetermined time period.

8. A method according to claim 5, wherein a single call is encrypted with new keys on the basis of random time periods.
